(19) United States
(12) Patent Application Publication
(10) Pub. No.: US 2016/0116031 A1
(43) Pub. Date: Apr. 28, 2016

(54) ENGINE PULLEY STRUCTURE OF HYBRID VEHICLE AND METHOD OF CONTROLLING THE SAME

(71) Applicant: Hyundai Motor Company, Seoul (KR)

(72) Inventors: Deuk Hoon Koh, Seoul (KR); Hyung Bin Ihm, Seoul (KR); Joo Young Park, Seoul (KR)

(21) Appl. No.: 14/676,999

(22) Filed: Apr. 2, 2015

(30) Foreign Application Priority Data
Oct. 28, 2014 (KR) 10-2014-0147544

(51) Int. Cl. F16H 7/08; B60W 20/00; B60K 6/387; F16H 7/02

(52) U.S. Cl. CPC F16H 7/0827; F16H 7/02; B60W 20/10; B60K 6/387; F16H 2007/0885; B60W 2710/021; Y10S 903/914; B60Y 2200/92

(57) ABSTRACT

An engine pulley structure of a hybrid vehicle and a method of controlling the same are provided. The engine pulley clutch structure includes a disc hub part that is configured to transfer or block power of an engine for the hybrid vehicle that has a hybrid starter generator (HSG) and an idle starter generator (ISG). A pulley part is linked with the disc hub part and is connected to a pulley of the engine by a belt. Additionally, a field coil part is linked with the pulley part to generate a magnetic field. The power is transferred by fastening the engine and the belt in the section in which the HSG and the ISG are operated within the hybrid vehicle.

### CROSS-REFERENCE TO RELATED APPLICATION

This application is based on and claims the benefit of priority to Korean Patent Application No. 10-2014-0147544, filed on Oct. 28, 2014 in the Korean Intellectual Property Office, the disclosure of which is incorporated herein in its entirety by reference.

### TECHNICAL FIELD

The present disclosure relates to an engine pulley structure of a hybrid vehicle and a method of controlling the same, and more particularly, to an engine pulley structure of a hybrid vehicle for transferring power by fastening an engine and a belt in a section in which a hybrid starter generator (HSG) and an idle starter generator (ISG) are operated within the hybrid vehicle and minimizing power consumed during the driving by releasing the fastening between the engine and the belt in a section in which the operations of the HSG and the ISG are unnecessary, and a method of controlling the same.

### BACKGROUND

In general, the HSG and the ISG perform an auxiliary function of an engine drive, similar to an engine starter motor of gasoline and diesel vehicles according to the related art. In particular, a representative difference between the HSG/ISG and the starter motor is that the starter motor uses vehicle auxiliary battery power of 12V, whereas the HSG consumes power of a high voltage battery of hybrid and plug-in hybrid vehicles and the ISG uses a voltage of 48V.

Meanwhile, a common ground is that the HSG/ISG and the starter motor are connected to an engine pulley by a belt. However, according to the related art, although the HSG/ISG and the starter motor do not perform other functions even after the engine is driven, the HSG/ISG and the starter motor are considered a load, due to a constant belt fastening condition with the engine, which results in a decrease in fuel efficiency.

### SUMMARY

The present disclosure provides an engine pulley structure of a hybrid vehicle and a method of controlling the same, and more particularly, an engine pulley structure of a hybrid vehicle for transferring power by fastening an engine and a belt in a section in which a hybrid starter generator (HSG) and an idle starter generator (ISG) are operated within the hybrid vehicle and minimizing power consumed during the driving by releasing the fastening between the engine and the belt in a section in which the operations of the HSG and the ISG are unnecessary, and a method of controlling the same.

According to an exemplary embodiment of the present disclosure, an engine pulley clutch structure of a hybrid vehicle may include: a disc hub part configured to transfer or block power of an engine for the hybrid vehicle having a hybrid starter generator (HSG) and an idle starter generator (ISG); a pulley part linked with the disc hub part and connected to a pulley of the engine by a belt; and a field coil part linked with the pulley part to generate a magnetic field.

The power of the engine may be transferred to a compressor. The pulley part may be connected to the belt to be rotatable, and may be configured to transfer the power of the engine to the compressor while power is applied to a clutch. The clutch may be an electromagnet clutch that performs a lock up/open operation by an electromagnet principle. Additionally, the power of the engine may be transferred to the compressor via a disc. The field coil part may be configured to generate a magnetic field while the power is being applied to the clutch.

According to another exemplary embodiment of the present disclosure, an engine pulley clutch structure of a hybrid vehicle may include: a disc hub part configured to transfer or block power of an engine for the hybrid vehicle that has a hybrid starter generator (HSG) and an idle starter generator (ISG) to or from a compressor; a pulley part linked with the disc hub part, connected to a pulley of the engine by a belt to be rotatable, and configure to transfer the power of the engine to the compressor while power is applied to a clutch; and a field coil part linked with the pulley part and configured to generate a magnetic field while the power is applied to the clutch. The clutch may be fastened to the engine to transfer the power when the HSG and the ISG are used, and the fastening with the engine may be released when the HSG and the ISG are not used.

According to another exemplary embodiment of the present disclosure, a method of controlling an engine pulley clutch of a hybrid vehicle may include: determining whether torque of a hybrid starter generator (HSG) and an idle starter generator (ISG) is 0; locking up an electromagnet clutch of a pulley part when the torque is not 0 (e.g., the torque is greater than 0); determining whether the torque of the HSG and the ISG is 0 after the lock up of the electromagnet clutch is performed; and opening the electromagnet clutch of the pulley part when the torque is 0. When the torque is not 0, the electromagnet clutch may be opened, and when the torque is 0, the electromagnet clutch may be locked up.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary diagram showing an engine pulley structure of a hybrid vehicle according to an exemplary embodiment of the present disclosure; and

FIG. 2 is an exemplary flowchart showing a method of controlling an engine pulley of a hybrid vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Exemplary embodiments of the present disclosure will be described in detail with reference to the accompanying drawings.

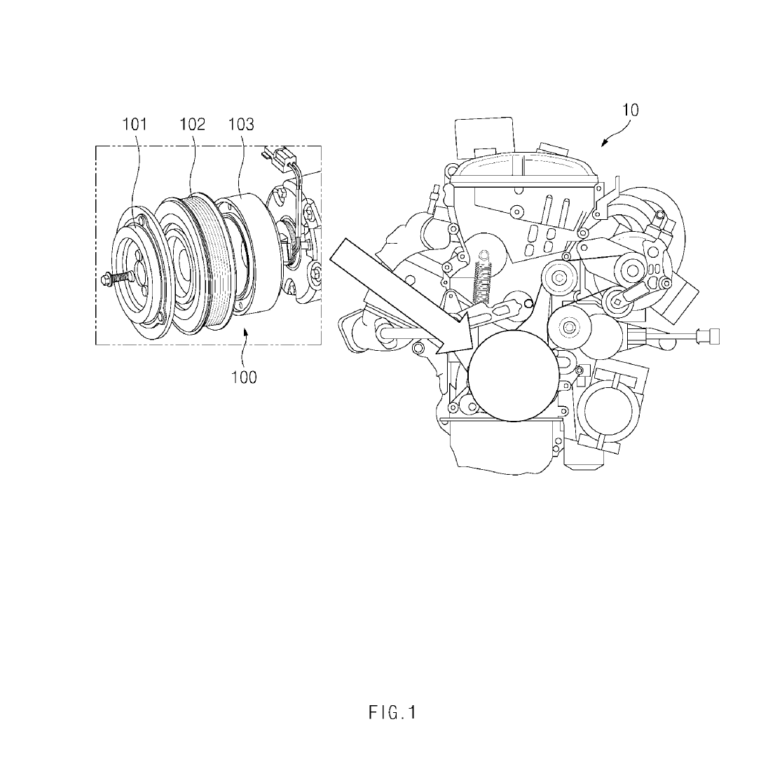

An engine pulley structure of a hybrid vehicle according to the present disclosure may include a disc hub part 101 configured to transfer or block power of an engine 10, a pulley part 102 connected to a pulley of the engine 10 by a belt (not shown), and a field coil part 103 configured to generate a magnetic field, as shown in FIG. 1.

The disc hub part 101 may be configured to transfer or block power of the engine 10 for the hybrid vehicle that has a hybrid starter generator (HSG) and an idle starter generator (ISG). In particular, the power of the engine 10 may be transferred to a compressor (not shown) through the disc hub part 101. Additionally, the power of the engine 10 may be transferred to the compressor through a disc. The pulley part 102 may be linked with the disc hub part 101 and may be connected to a crank pulley of the engine 10 by the belt (not shown) to allow the power to be transferred.

Further, the pulley part 102 may be connected to the belt to be rotatable, and may be configured to transfer the power of the engine 10 to the compressor when power is applied to a clutch 100. In particular, as the clutch 100, an electromagnet clutch configured to lock up or open by an electromagnet principle may be used. The field coil part 103 may be linked with the pulley part 102 to generate the magnetic field. The field coil part 103 may be configured to generate the magnetic field when power is applied by the link with the clutch 100. Meanwhile, when the HSG and the ISG are used, the clutch may be fastened to the engine 10 to transfer the power, and when the HSG and the ISG are not used (e.g., are not operated), the fastening with the engine 10 may be released.

As described above, the fastening portion with the engine 10 may be changed in a form of the clutch 100, the electromagnet clutch configured to lock up and open the corresponding clutch by the electromagnet principle is mounted, the clutch 100 of one side is magnetized by applying a current to a coil that surrounds the clutch in a section in which an HSG/ISG torque instruction is not 0 (e.g., is greater than 0), and the clutch 100 of one side (e.g., a first side) is coupled to the clutch 100 of the other side (e.g., a second side) by magnetic force generated from the magnetized clutch 100 of one side, thereby generating the lock up of the clutch 100.

Particularly, in the lock up state, a current necessary to maintain the lock up may constantly flow in the coil, and once the HSG/ISG torque instruction becomes 0, the corresponding current may be blocked and the clutch 100 may be opened by a spring having elastic coefficient necessary to restore the clutch 100 of one side, as shown in FIG. 1. In addition, when a rotor of the HSG/ISG is rotated during the driving of the engine 10 regardless of whether the torque instruction is present, since the rotor is stopped in an open section when a proposed clutch is used and loss due to a belt driving for rotating the rotor of the HSG/ISG generated during the rotation of an existing engine 10 may be greater than power loss generated during the lock up of the proposed clutch 100 within one driving cycle, fuel efficiency may be improved as much as loss reduction (e.g., may be improved relative to the loss reduction).

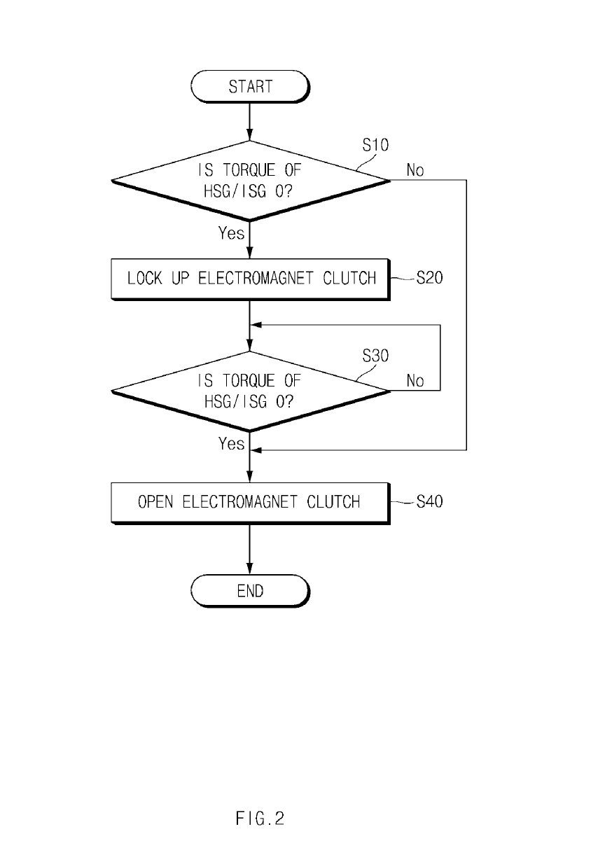

A method of controlling an engine pulley of a hybrid vehicle according to the present disclosure may include determining, by a controller, torque of HSG and ISG, locking up an electromagnet clutch of a pulley part 102, determining, by the controller, the torque of the HSG and the ISG after locking up the electromagnet clutch, and opening the electromagnet clutch of the pulley part 102, as shown in FIG. 2.

In particular, whether the torque of the HSG and the ISG is 0 may be determined before locking up the electromagnet clutch When the torque is 0, the electromagnet clutch of the pulley part 102 may be locked up to constantly supply a current. Further, the controller may be configured to determine whether the torque of the HSG and the ISG is 0 after the electromagnet clutch is locked up. When the torque is 0, the electromagnet clutch of the pulley part 102 may be opened to stop a rotor of the HSG/ISG. In particular, when the torque is not 0 in the first torque determination process, the electromagnet clutch may be opened, and when the torque is not 0 in the second torque determination process, the electromagnet clutch of the pulley part 102 may be locked up.

As described above, the fastening portion with the engine 10 may be changed in a form of the clutch, the electromagnet clutch that performs the lock up and open operation of the corresponding clutch by the electromagnet principle is mounted, the clutch 100 of one side may be magnetized by applying a current to a coil that surrounds the clutch in a section in which an HSG/ISG torque instruction is not 0, and the clutch 100 of one side may be coupled to the clutch 100 of the other side by magnetic force generated from the magnetized clutch 100 of one side, thereby generating the lock up of the clutch 100. In particular, in the lock up state, a current necessary to maintain the lock up may constantly flow in the coil, and once the HSG/ISG torque instruction becomes 0, the corresponding current may be blocked and the clutch 100 may be opened by a spring having elastic coefficient necessary to restore the clutch 100 of one side.

In addition, when a rotor of the HSG/ISG is rotated during the driving of the engine 10 regardless of whether the torque instruction is present, since the rotor is stopped in an open section when the clutch 100 is used and loss due to a belt driving for rotating the rotor of the HSG/ISG generated during the rotation of an existing engine 10 may be greater than power loss generated at the time of the lock up of the proposed clutch 100 within one driving cycle, fuel efficiency may be improved as much as loss reduction.

As described above, according to the exemplary embodiments of the present disclosure, the power may be transferred by fastening the engine and the belt in the section in which the HSG and the ISG are operated within the hybrid vehicle and the power consumed during the driving may be reduced and the engine load may be decreased by releasing the fastening between the engine and the belt in the section in which the operations of the HSG and the ISG are unnecessary, thus improving fuel efficiency.

As described above, although the present disclosure has been described with reference to exemplary embodiments and the accompanying drawings, it would be appreciated by those skilled in the art that the present disclosure is not limited thereto but various modifications and alterations might be made without departing from the scope defined in the following claims.

What is claimed is:

1. An engine pulley clutch structure of a hybrid vehicle, comprising:
a disc hub part configured to transfer or block power of an engine for the hybrid vehicle that has a hybrid starter generator (HSG) and an idle starter generator (ISG);
a pulley part linked with the disc hub part and connected to a pulley of the engine by a belt; and
a field coil part linked with the pulley part to generate a magnetic field.

2. The engine pulley clutch structure according to claim 1, wherein the power of the engine is transferred to a compressor.

3. The engine pulley clutch structure according to claim 2, wherein the pulley part is connected to the belt to be rotatable, and is configured to transfer the power of the engine to the compressor when power is applied to a clutch.

4. The engine pulley clutch structure according to claim 3, wherein the clutch is an electromagnet clutch configured to lock up and open the clutch by an electromagnet principle.

5. The engine pulley clutch structure according to claim 3, wherein the power of the engine is transferred to the compressor through a disc.

6. The engine pulley clutch structure according to claim 3, wherein the field coil part is configured to generate a magnetic field when the power is applied to the clutch.

7. An engine pulley clutch structure of a hybrid vehicle, comprising:
a disc hub part configured to transfer or block power of an engine for the hybrid vehicle that has a hybrid starter generator (HSG) and an idle starter generator (ISG) to or from a compressor;
a pulley part linked with the disc hub part, connected to a pulley of the engine by a belt to be rotatable, and configured to transfer the power of the engine to the compressor when power is applied to a clutch; and
a field coil part linked with the pulley part and configured to generate a magnetic field when the power is applied to the clutch.

8. The engine pulley clutch structure according to claim 7, wherein the clutch is fastened to the engine to transfer the power when the HSG and the ISG are used, and the fastening with the engine is released when the HSG and the ISG are not used.

9. A method of controlling an engine pulley clutch of a hybrid vehicle, the method comprising:
determining, by a controller, whether torque of a hybrid starter generator (HSG) and an idle starter generator (ISG) is 0;
locking up an electromagnet clutch of a pulley part when the torque is 0;
determining, by the controller, whether the torque the HSG and the ISG is 0 after the locking up the electromagnet clutch; and
opening the electromagnet clutch of the pulley part when the torque is 0.

10. The method according to claim 9, wherein when the torque is not 0 in the first determination process, the electromagnet clutch of the pulley part is opened, and when the torque is not 0 in the second determination process, the locking up the electromagnet clutch of the pulley part.
